(19) United States
(12) Patent Application Publication
(10) Pub. No.: US 2012/0195304 A1
(43) Pub. Date: Aug. 2, 2012

(54) VOIP CONTENT DELIVERY AND CONTROL MANAGER

(76) Inventor: Steve Lawrence Fogel, Miramar, FL (US)

(21) Appl. No.: 13/352,972

(22) Filed: Jan. 18, 2012

Related U.S. Application Data
(60) Provisional application No. 61/433,682, filed on Jan. 18, 2011.

(51) Int. Cl. H04L 12/66

(52) U.S. Cl. 370/352

(57) ABSTRACT

A method and system of delivering and managing audio and video content, comprising: receiving, over at least one computer, at least one audio and/or video file to be played using at least one VOIP audio and video PBX telephone system; managing remotely, using at least one computer application, the at least one audio and/or video file; and distributing the at least one audio and/or video file to the at least one VOIP audio and/or video PBX telephone system.

### CROSS-REFERENCE TO RELATED APPLICATIONS

This application claims the benefit of U.S. Provisional Patent Application No. 61/433,682, filed Jan. 18, 2011, which is incorporated by reference in its entirety.

### BRIEF DESCRIPTION OF THE DRAWINGS

FIG. 1 depicts a prior art VOIP (Voice Over Internet Protocol) telephony switch, according to an embodiment of the present invention.

FIG. 2 depicts a VOIP Audio and Video PBX Telephone System, according to an embodiment of the present invention.

FIG. 3 depicts a VOIP Audio and Video PBX control Manager System, according to one embodiment of the present invention.

FIGS. 4-7 are screen shots illustrating use of the VOIP video and audio switch, according to one embodiment of the present invention.

### DESCRIPTION OF EMBODIMENTS OF THE INVENTION

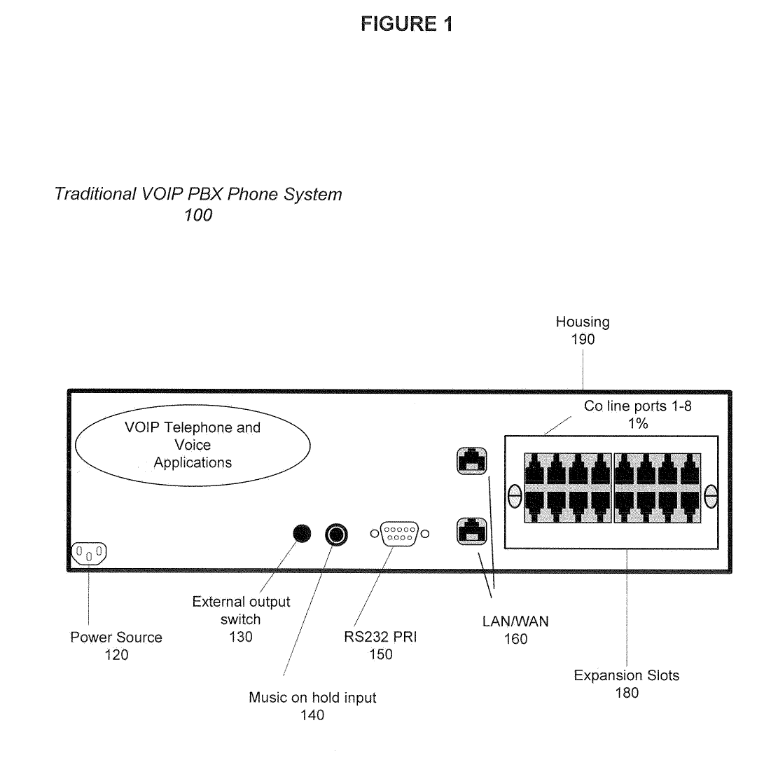

FIG. 1 depicts a prior art VOIP telephony switch 100. The switch 100 may be disposed in a housing 190. The housing 190 may have several interfaces allowing it to be operably connected to other devices or networks. These interfaces may include at least one: power source input 120, external output switch port 130, music on hold input port 140, Recommended Standard 232 (RS232) input/output port 150, Local Area Network/Wide Area Network (LAN/WAN)input/output port 160, central office (CO) line port 170, or expansion slot 180, or any combination thereof. The housing may house at least one processor (not shown) which may run at least VOIP telephone and voice applications 110. The power source input 120 can be a standard AC power input. The external output switch port 130 can allow phone pages to be sent to external audio systems. The music on hold input port 140 can allow an external music source to be played when a caller is placed on hold. The RS232 input/output port can allow a computer or control device to be attached to a system for the purposes of making program changes and/or program updates. The LAN/WAN input/output port 160 can allow connection to a WAN or connection to local devices using, for example, an Ethernet LAN connection. The CO line port 170 can allow central office telephone line ports to attach to phone hand sets. The expansion slot(s) 180 can allow for additional phone lines.

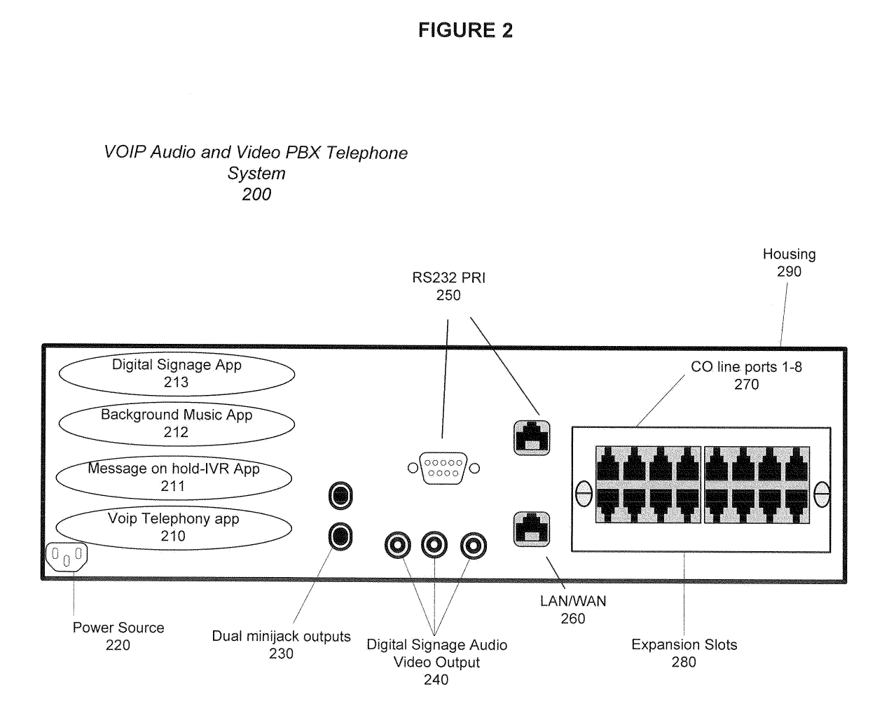

FIG. 2 depicts a VOIP audio and video PBX telephone system 200, according to an embodiment of the invention. The VOIP audio and video PBX telephone system 200 can be enabled to collect from the Internet (from a control manager server 320, described below), and then store and distribute both audio and video files (e.g., digital signage and background music, video). These audio and video files can be managed remotely by a computer (e.g., remote device 330 such as a smart phone, personal digital assistant (PDA), etc.) utilizing a network (e.g., Internet 300), which can eliminate the use of dedicated media servers or proprietary storage devices to: collect, store, or distributed audio and video content, or any combination thereof. In this way, there can be centralized audio and video content control. In addition, existing VOIP PBX system infrastructure can be used, which can eliminate duplicate hardware (eliminating, e.g., maintenance costs). Furthermore, multiple channels of content can be combined and distributed. Additionally, the cost of design and distribution of content can be simplified and reduced.

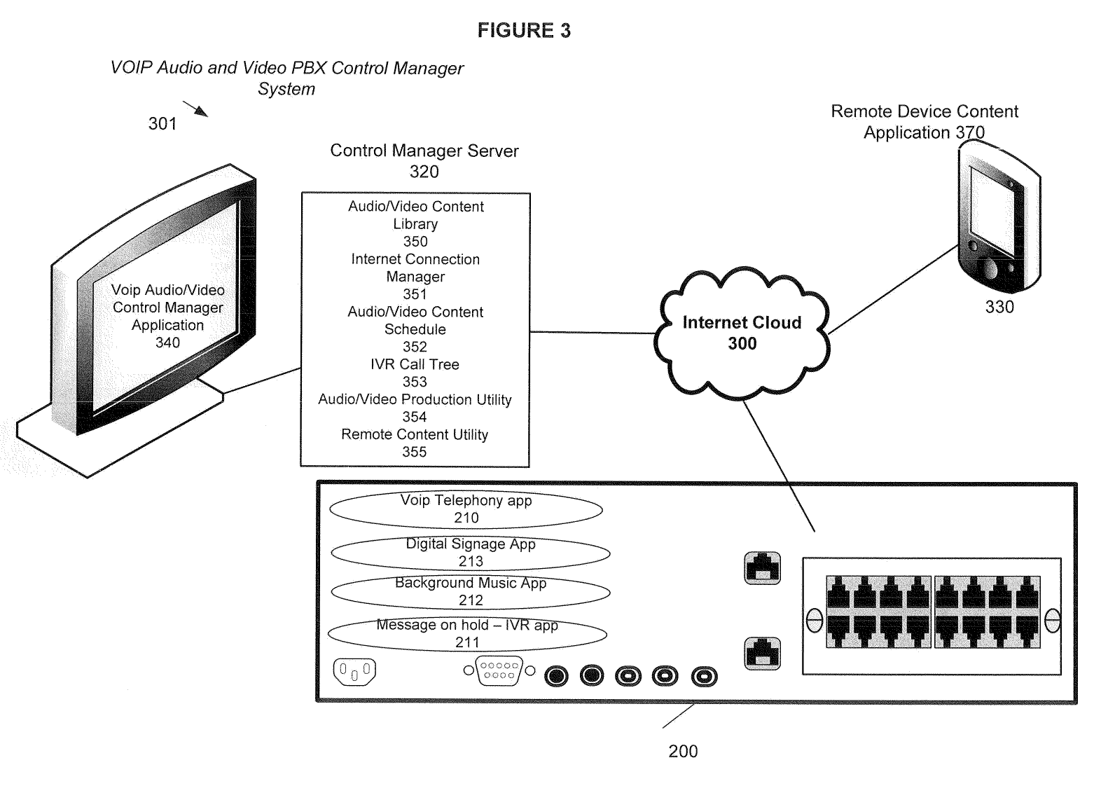

The VOIP audio and video PBX telephone system 200 may be disposed in a housing 290. The housing 290 may have several interfaces allowing it to be operably connected to other devices or networks. As with the embodiment of FIG. 1 above, these interfaces may include at least one: power source input 220, RS232 input/output port 250, LAN/WAN input/output port 260, co line port 270, or expansion slot 280, or any combination thereof. These elements can function as described above. The VOIP audio and video PBX telephone system 200 may also have at least one dual minijack outputs 230 and at least one digital signage audio and video output 240. The dual minijack outputs 230 can be used to deliver both audio and/or video output for background music and/or video applications. The digital signage audio and video output 240 can enable VOIP audio and video PBX telephone system 200 to distributed multiple channels of content (e.g., through speaker systems, kiosk or digital signage applications). The housing 290 may house at least one processor (not shown) which may run at least one: VOIP telephony application 210, message on hold IVR application 211, background music application 212, or digital signage applications 213, or any combination thereof. These applications can allow VOIP audio and video PBX telephone system 200 to be controlled remotely by utilizing the VOIP audio/video control manager application 340 (described below in FIG. 3). The VOIP telephone application 210 can be a basic application that can reside on all VOIP systems which can give the VOIP systems their basic VOIP telephony functionality. The message on hold IVR application 211, which can reside in the VOIP audio and video PBX telephone system 200 that can be integrated with the control manager server 320 (of FIG. 3), can allow storing and/or playing of messages on hold and/or integrated voice response audio files, and can also be updated and/or maintained remotely. The background music application 212, which can reside in the VOIP audio and video PBX telephone system 200 and can be integrated with the control manager server 320, can allow storing and playing of background music files for external broadcasting, and can also be updated and/or maintained remotely. The digital signage application 213, which can reside in the VOIP audio and video PBX telephone system 200 and can be integrated with the control manager server 320, can enable storing and distribution of audio and/or video files, and can also be updated and/or maintained remotely. Those of ordinary skill in the art will see that some or all of the elements of the VOIP audio and video PBX telephone system 200 do not need to be used, and that many other elements can be added to the VOIP audio and video PBX telephone system 200.

FIG. 3 depicts a VOIP audio and video PBX control manager system, according to an embodiment of the invention. A VOIP audio and video PBX telephone system 200 may be connected to at least one network such as the Internet 300. At least one VOIP audio and/or video control manager application 340 can manage one or more applications that can reside on control manager server 320, which can control remote or local telephony switches, using, for example, at least one remote device 330. (It should be noted that any device with a computer may be used instead of or in addition to the remote device 330.) The VOIP audio and video PBX telephone system 200, control manager server 320, and/or remote device 330 can communicate with one another through the Internet 300 in ways that are well known in the relevant art.

The VOIP audio and video PBX telephone system 200 is described in FIG. 2. The VOIP audio/video PBX control manager system 340 can be an application (e.g., either remote from, connected to, and/or part of control manager server 320) that can enable the user to manage content remotely from any remote browser utilizing at least one application. The audio/video control manager application 340 may be able to control at least: an audio/video content library 350, an Internet connection manager 351, an audio/video content schedule utility 352, an Interactive Voice Response (IVR) call tree utility 353, an audio production utility manager application 354, or a remote content utility 355, or any combination thereof. These elements 350-355 can be integrated and can enable the management of production, storage, scheduling and distribution of both audio and video files located in the VOIP telephony switch. The audio/video content library 350 can store content and enable the user to create and store content for distribution. The Internet connection manager 351 can enable the content server to connect to the VOIP audio and video PBX ‘telephone system 200 using standard protocols using push or pull technology, which can help ensure maximum security. The audio/video content schedule utility 352 can allow numerous scheduling options for audio and video content. The IVR call tree utility 353 can interpret and store relevant data to enable the remote distribution of audio files used in the VOIP audio and video PBX telephone system 200. The audio production utility 354 can allow the user to request audio file production for use with message on hold application, IVR application, or background music application, or any combination thereof. The remote content utility 355 can allow for content management from an Internet connected remote device 330.

The remote device 330 may include a remote device content application 370 and/or another type of client content application, which may allow for content management from an Internet connected smart phone or similar device. The remote device content application 370 can allow access to the control manager server 320, for example, using the VOIP audio/video control manager application 340, in order to make changes to the VOIP audio and video PBX telephone system 200.

For example, in one embodiment, the VOIP audio and video PBX telephone system 200 can be controlled from any device (remote). The control manager server 320 can sit at a host location and elements 350-355 can be controlled using, for example, the VOIP audio/video control manager application 340. For example, a user can use remote device 330 to communicate to VOIP audio/video control manager application 340 (e.g., through control manager server 320) what it would like to do. Then, VOIP audio/video control manager application 340 can then communicate with the element to do what the user has indicated. (It should be noted that, in some embodiments, a user can simply send a message (e.g., using email, voicemail, text, etc.) to the host with instructions, and the host can use the VOIP audio/video control manager application 340 to carry out the user's instructions).

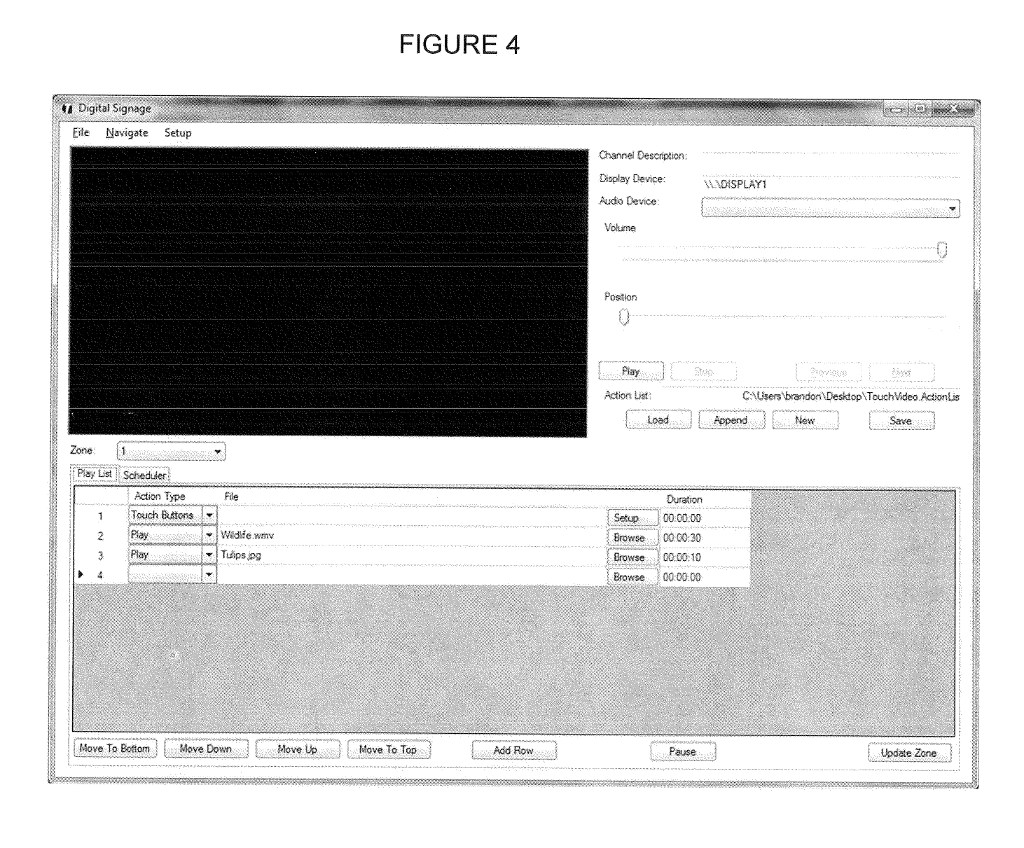

For example, with respect to the audio/video content library 350, a user can change the, content. The audio/video content library 350 can store many audio and/or video files. Each audio and/or video file can have several songs and/or video, with other audio and/or video content mixed in. For example, a grocery store chain can play a set of Christmas music with commercials (e.g., about that grocery store chain and/or location, local commercials, national commercials, or any combination thereof, etc.) (e.g., audio only) in some locations, and show recordings (or, in some embodiments, a live feed) of local news (e.g., video and audio) with commercials in other locations. A manager of the grocery store chain or a manager of a particular grocery store can control which files (e.g., combinations of songs with commercials or combinations of news and commercials) be played at which time. In addition, new content (e.g., new songs, new news segments, or any other audio and/or video content) can be added to certain files, or new files can be created with the new content. It should be noted that the user can also indicate that certain screens should shown at specific times within a file or added into a file. FIGS. 4-7 show more details about this ability, according to one embodiment.

As another example, with respect to the audio/video content schedule 352, a user can indicate that, starting the day after thanksgiving at midnight until January 2 at midnight, a certain file containing Christmas music, with specific messages about special deals in the store played intermittently with Christmas music, should be played. In addition, certain files can be played at certain places. For example, the audio/video content schedule 352 can schedule a certain audio and video file to be shown in the elevator and at check-out of a store, and another audio file to be played over the store's intercom system.

The Internet connection manager 351 can be used to allow the control manager server 230 to connect to the VOIP audio and video PBX telephone system 200 per the Internet 300. (It should be noted that other networks other than the Internet can also be used.) As each client may have different firewalls, protocols, etc., the Internet connection manager 351 can configure the settings for each customer appropriately so the customer's VOIP audio and video PBX telephone system 200 can communicate with the control manager server 320 to get information on what it should show and when.

The IVR call tree utility 353 can control what files from the audio/video content library 350 are played and when. For example, if a user sets up company phones to answer with a set of options 1-5, and options 1 and 3 have 4 more options each, the IVR call tree utility 353 can manage that tree hierarchy. The IVR call tree utility 353 can indicate that there is a slot open in case a user wishes to change or add to the options.

The audio/video production utility 354 allows users to send requests regarding audio and/or video content that a user would like created. For example, a user could indicate that a message that there is a sale on a certain product on certain days to be played over the speakers, the audio/video production utility 354 can: put this request in the production cycle, get a script writer to write the audio commercial, find talent to record the audio commercial, mix the audio commercial in with background music, get approval for the commercial, or load the commercial into an already-existing file (or create a new file) in the audio/video content library 350, or any combination thereof.

The remote content utility 355 can work with the remote device 330 and the remote device content application 370 on the remote device 330 to allow the user to control what is sent and when to the VOIP audio and video PBX telephone system 200, as described above. It should be noted that any device with a computer could be used instead of or in addition to the remote device 330, and that a utility could be used to communicate with software on the device, similar to how the remote content utility 355 communicates with the remote device content application 370.

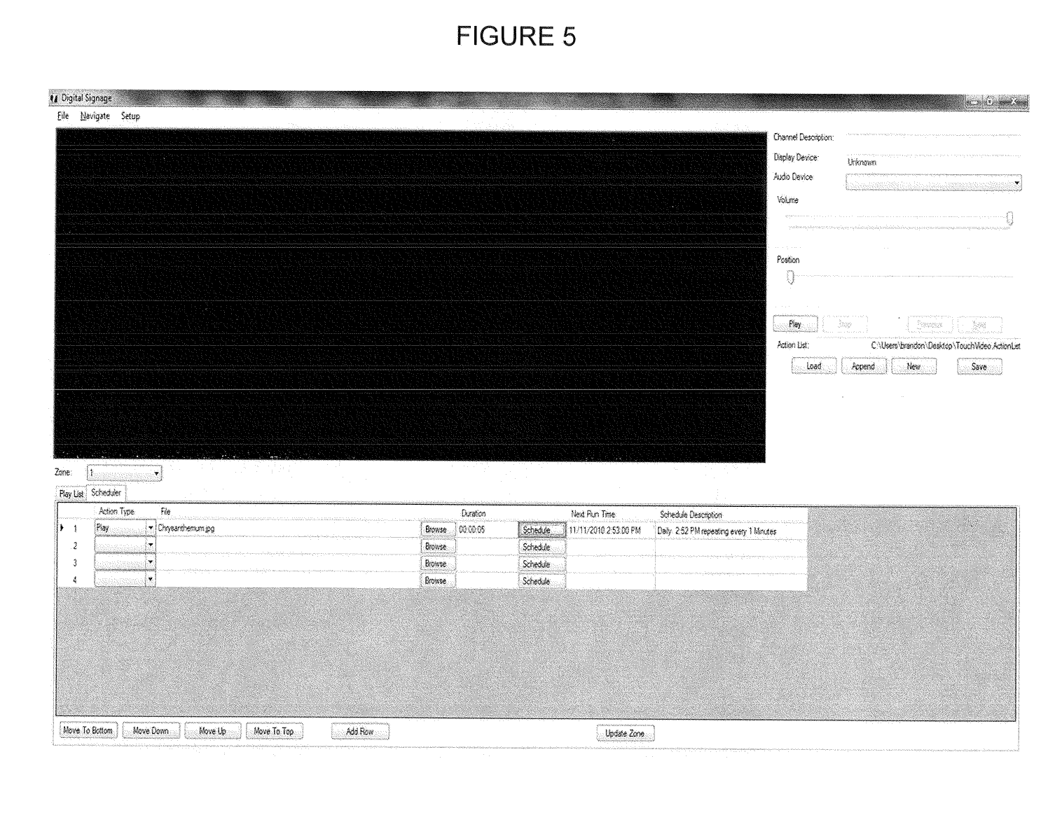

FIGS. 4-7 illustrate various screen shots that can be utilized in system 301, according to one embodiment. FIG. 4 is a screen shot illustrating how a user can set up which files will be played. In this example, the files “wildlife.wmv” and “tulips.jpg” can be set up to be played. FIG. 5 is another screen shot illustrating how a user can indicate which files should be played. In this example, the user can indicate that the file “chrysanthemum.jpg” can be played for 5 seconds, every minute of every day. The following can also be set by the user: channel description, display device, audio device, volume, position, or action list, or any combination thereof. In addition, the user can play the file, for example, in order to review the content.

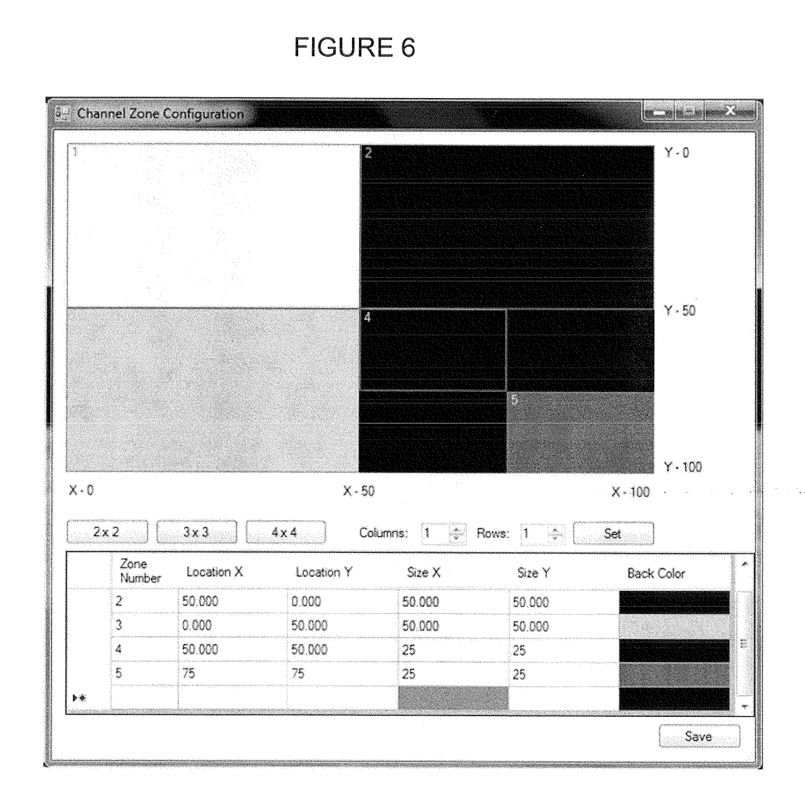

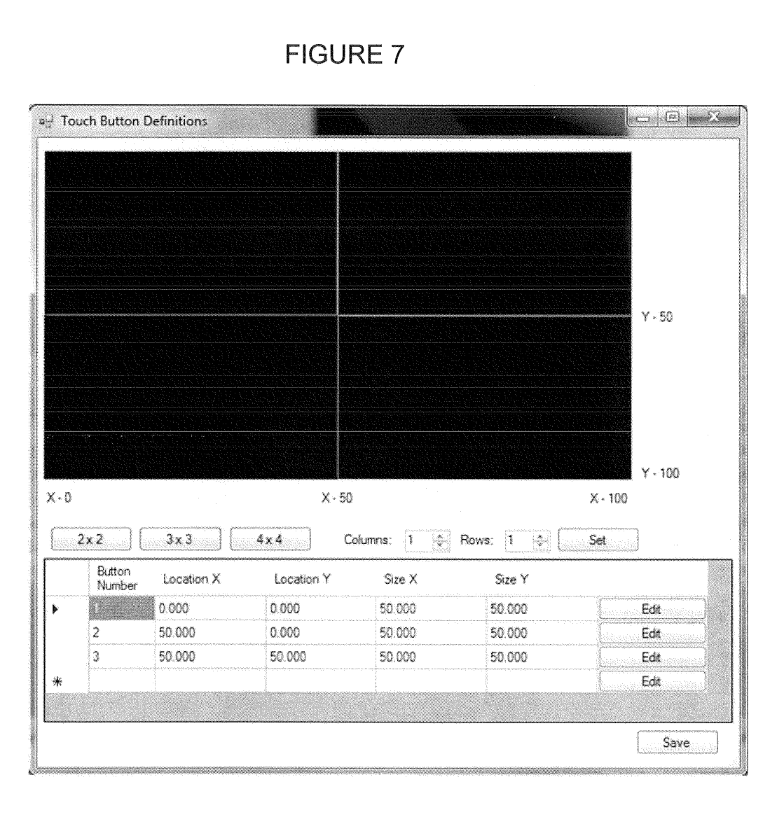

FIGS. 6 and 7 are screen shots illustrating how a user can control the zones of a display, according to one embodiment. For example, in FIG. 6, five zones are set up on the screen: 1, 2, 3, 4, and 5. The user can indicate the location on the X and Y coordinate maps where the zone is to start, how big the zone is, and the background color of the zone. For example, zone 2 starts at 0.5 and has a size of 50 points on the X coordinate map, and zone 2 starts at 0 and has a size of 50 points on the Y coordinate map. Zone 2 is also designated as having a dark background color. FIG. 7 is similar to FIG. 6, except that button numbers are designated.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method of delivering and managing audio and/or video content, comprising:
receiving, over at least one computer, at least one audio and/or video file to be played using at least one VOIP audio and video PBX telephone system;
managing remotely, using at least one computer application, the at least one audio and/or video file; and
distributing the at least one audio and/or video file to the at least one VOIP audio and video PBX telephone system.

2. The method of claim 1, comprising:
storing, using the at least one computer application, the at least one audio and/or video file.

3. The method of claim 1, wherein the at least one computer application is at least one Internet-enabled application that is capable of running on at least one Internet-enabled computer.

4. The method of claim 1, wherein the managing remotely is done on at least one computer.

5. The method of claim 4, wherein the at least one computer is in at least one mobile device.

6. The method of claim 1, wherein at least one user is able to request, modify and create digital signage applications with at least one audio capability.

7. The method of claim 1, wherein the VOIP audio and/or video PBX telephone system comprises: at least one digital signage application; at least one background music application; or at least one video application; or any combination thereof.

8. A system for delivering and managing audio and/or video content, comprising:
at least one processor configured for:
receiving at least one audio and/or video file to be played using at least one VOIP audio and video PBX telephone system
managing remotely the at least one audio and/or video file; and
distributing the at least one audio and/or video file to the at least one VOIP audio and video. PBX telephone system.

9. The system of claim 8, wherein the at least one processor is further configured for:
storing the at least one audio and/or video file.

10. The system of claim 9, wherein the at least one audio and/or video file is stored in a remote database.

11. The system of claim 8, wherein the at least one processor utilizes at least one Internet-enabled application that is capable of running on at least one Internet-enabled computer.

12. The system of claim 8, wherein the managing remotely is done on at least one computer.

13. The system of claim 12, wherein the at least one computer is in at least one mobile device.

14. The system of claim 8, wherein at least one user is able to request, modify and create digital signage applications with at least one audio capability.

15. The system of claim 8, wherein the at least one audio and/or video file is distributed to at least one display.

16. The system of claim 8, wherein the VOIP audio and/or video PBX telephone system comprises at least one digital signage application and/or at least one background music application.
